(19) United States
(12) Patent Application Publication
(10) Pub. No.: US 2003/0109993 A1
(43) Pub. Date: Jun. 12, 2003

(54) Method and apparatus for determining the presence and/or absence and/or a characteristic of an object on a support

(76) Inventors: Donald Peat, Wellington (NZ); Arnim Holger Littek, Wellington (NZ)

Correspondence Address: ROTHWELL, FIGG, ERNST & MANBECK, P.C., 1425 K STREET, N.W., SUITE 800, WASHINGTON, DC, 20005, US

(21) Appl. No.: 10/312,839

(22) PCT Filed: Jul. 3, 2001
(86) PCT No.: PCT/NZ01/00134

(30) Foreign Application Priority Data
Jul. 3, 2000 (NZ) 505544

(51) Int. Cl. G01N 29/00

(52) U.S. Cl. 702/56; 73/649; 73/579

(57) ABSTRACT

A method of determining the presence and/or absence and/or a characteristic of an object on a support (4). The method includes the steps of: a) acquiring a target signal indicative of vibration of the support at a first location; b) acquiring a reference signal, the reference signal being indicative of vibration of the support at a second location; c) calculating a ratio of the target signal and the reference signal; and d) determining the presence and/or absence and/or a characteristic of an object on the support in accordance with the ratio determined in step c).

### FIELD OF THE INVENTION

The present invention relates to a method and apparatus for determining the presence and/or absence and/or a characteristic of an object on a support, such as a seat.

### BACKGROUND OF THE INVENTION

A method of determining the presence of a human on a car seat is described in WO 00/13582. A target signal is acquired from a first transducer on the front side of the back-rest of the seat. A reference noise signal is acquired by a second transducer positioned on the rear side of the back-rest of the seat. The reference noise signal is subtracted from the target signal to generate a cardiac signal. The cardiac signal is then analysed to determine the presence or absence of a seat occupant.

### OBJECT AND STATEMENT OF THE INVENTION

A problem with the approach of WO 00/13582 is that it can be difficult to determine the presence or absence of a seat occupant from the cardiac signal if there are large interfering noises, such as may be caused by vigorous motion, particularly if it is near in frequency to the cardiac signal. Also it is not possible to detect the presence or absence of an inanimate object on the seat.

An object of the invention is to at least address these problems, or at least to provide the public with a useful choice.

A first aspect of the invention provides a method of determining the presence and/or absence and/or a characteristic of an object on a support, the method including the steps of:

a) acquiring a target signal indicative of vibration of the support at a first location;

b) acquiring a reference signal indicative of vibration of the support at a second location;

c) calculating a ratio of the target signal and the reference signal; and

d) determining the presence and/or absence and/or a characteristic of an object on the support in accordance with the ratio determined in step c).

Instead of subtracting the two signals, we calculate a ratio of the target and reference signals. The reference signal can be considered to be an input to the mechanical system formed by the support and object (if any). Similarly the target signal can be considered to be an output of the system.

According to classical control system theory, the ratio of the output to the input is defined as the transfer function of the system. Thus the present invention effectively measures the transfer function of the mechanical system, and from this deduces information about the object (if any) on the support.

The method is not sensitive to noise, and in fact can positively utilise system noise to perform the measurement.

The ratio may be calculated directly by dividing the target and reference signals. Alternatively the ratio may be calculated indirectly by separately calculating logarithmic values (such as decibel values) for the target and reference signals, and then subtracting the logarithmic values.

The reference and target signals may be acquired directly from vibration sensors. However a problem with dividing these raw, unprocessed vibration signals is that the target signal will periodically pass through zero, resulting in a mathematical error. Therefore preferably the target signal is acquired in step a) by receiving a target vibration signal from a sensor mounted on the support at the first location and processing the target vibration signal to calculate a first signal characteristic which varies in accordance with the presence and/or absence and/or a characteristic of an object on the support; and the reference signal is acquired in step c) by acquiring a reference vibration signal and processing the reference vibration signal to calculate a second signal characteristic; and wherein step c) includes the step of calculating the ratio of the first and second signal characteristics. Therefore we process the signals (to calculate the signal characteristics) before step c). This can be contrasted with the conventional differential processing of WO 00/13582, in which the cardiac signal is only analysed after signal subtraction.

Typically the processing steps each include analogue-to-digital conversion of the signal to generate signal values. Typically a plurality of the signal values are processed to calculate the signal characteristic—for instance the processing steps will typically each include a summing step. The plurality of values may be processed on the fly, or may be stored as part of the processing steps.

In a ‘time domain’ example the first and second signal characteristics are indicative of an average power of vibration of the support at the first and second locations during a predetermined time period. In a ‘frequency domain’ example the signals are indicative of a power of vibration of the support at the first and second locations in a predetermined wavelength band. In a third example the first and second signal characteristics are correlation coefficients indicative of a degree of correlation between the vibration signals and a predetermined encoded sequence, such as a pseudo-random sequence.

In a passive system the reference signal may be acquired in step b) from a reference sensor mounted at the second location. This is suitable in a noisy environment such as a car. The reference sensor is typically mounted on or in the support, for instance at a point where the support is fixed to a vehicle in which it is housed. Alternatively the target sensor may be mounted on the vehicle remote from the support.

In a less noisy environment (such as a hospital bed) the support may need to be actively vibrated at the second location. In an active system the reference signal may be acquired from a reference sensor, or may be acquired directly from a signal generator.

A variety of techniques may be used to analyse the ratio and generate a suitable output. In a preferred example a plurality of ratio values are calculated in step c); and the presence and/or absence and/or a characteristic of an object on the support is determined in step d) by performing a pattern recognition algorithm on the plurality of ratio values. A pattern recognition network can be trained to perform the pattern recognition algorithm by inputting a plurality of sets of training data values into the pattern recognition network.

At a minimum, step d) may output a bi-level signal which is simply indicative of the presence or absence of an object on the support above a predetermined weight. Alternatively, if the system is sensitive enough then a multi-level output may be possible. In one embodiment, step d) includes the step of distinguishing between different categories of object, such as animate/inanimate objects.

Typically the support includes a compressible material (such as foam) between the first and second locations.

Typically the first location is positioned below a support surface which carries the object.

In one example the support is a seat having a base for supporting the buttocks of an occupant, and the first location is situated in the base. This can be contrasted with the arrangement in WO 00/13582, in which the target sensor is mounted in the back-rest of the seat. In another example the support is a bed having a mattress, and the first location is situated in the mattress.

At a minimum only a single target signal is acquired in step a). Alternatively a plurality of target sensors may be employed. In this case the method further includes the steps of: acquiring one or more additional target signals indicative of vibration of the support at one or more additional locations; calculating one or more additional ratios using the additional target signal(s); and determining the presence and/or absence and/or a characteristic of an object on the support in step d) in accordance with the additional ratio(s). The additional ratios may be calculated using only a single reference signal, or using a plurality of reference signals

An additional target sensor can be mounted at a generally unloaded part of the support (for instance the edge of the base of a seat) so that it can be used as a reference to compare with a target sensor mounted at a loaded part of the support (for instance the centre of the base of the seat).

Typically the method is employed to sense a human or animal subject on the support.

The determining step d) typically includes the step of comparing the ratio with a predetermined threshold to determine the presence and/or absence of an object on the support. However it is conceivable that the ratio could give data of sufficient accuracy and reliability to enable it to be used to measure the weight, or another characteristic, of an object on the support.

The invention may be employed in a stationary support such as a hospital bed. However the invention is particularly suited to a noisy environment such as a land, water, air or space-based vehicle. The determination in step d) can then be used in a number of ways, for instance to enable and/or disable an airbag system.

The invention also extends to apparatus for performing the method of the first aspect of the invention.

A second aspect of the invention provides method of determining the presence and/or absence and/or a characteristic of an object on a support, the method comprising

a) acquiring a first signal from a first vibration sensor mounted to the support at a first location;

b) processing the first signal to calculate a first signal characteristic which varies in accordance with the presence and/or absence and/or weight of an object on the support;

c) acquiring a second signal from a second vibration sensor mounted at a second location;

d) processing the second signal to calculate a second signal characteristic;

e) comparing the first and second signal characteristics; and

f) determining the presence and/or absence and/or weight of an object on the support in accordance with the comparison in step e).

A third aspect of the invention provides apparatus for determining the presence and/or absence and/or a characteristic of an object on a support, the apparatus comprising

a) a first vibration sensor mounted to the support at a first location;

b) means for processing a first signal from the first vibration sensor to calculate a first signal characteristic which varies in accordance with the presence and/or absence and/or weight of an object on the support;

c) a second vibration sensor mounted at a second location;

d) means for processing a second signal from the second vibration sensor to calculate a second signal characteristic;

e) means for comparing the first and second signal characteristics; and

f) means for determining the presence and/or absence and/or weight of an object on the support in accordance with the comparison in step e).

### BRIEF DESCRIPTION OF THE DRAWINGS

A number of embodiments of the present invention will now be described with reference to the accompanying drawings, in which

FIG. 1 is a schematic view of a car with a pair of vibration sensors;

FIG. 2 is a mechanical analogy of the system of FIG. 1;

FIG. 3 is a schematic view of the passive passenger presence detection (PPPD) electronics;

FIG. 4 is a flow chart showing a time domain PPPD algorithm;

FIG. 5 is a flow chart showing a frequency domain PPPD algorithm;

FIG. 6 is a typical transfer function obtained with the seat unloaded (vertical axis dB, horizontal axis Hz);

FIG. 7 is a typical transfer function obtained with the seat loaded with an adult weighing approximately 80 kg;

FIG. 8 shows the time domain signals from the reference sensor (upper signal) and target sensor (lower signal) with the seat loaded (vertical axis volts, horizontal axis seconds);

FIG. 9 is a flowchart showing a second frequency domain method;

FIG. 10 is a schematic graph showing four different transfer functions;

FIG. 11 is a plan view of a sensor array;

FIG. 12 is a schematic side view of a bed with a active sensing system; and

FIG. 13 is a schematic view of the active sensing system; and

FIG. 14 is a schematic view of an alternative active sensing system.

### DETAILED DESCRIPTION OF PREFERRED EMBODIMENT

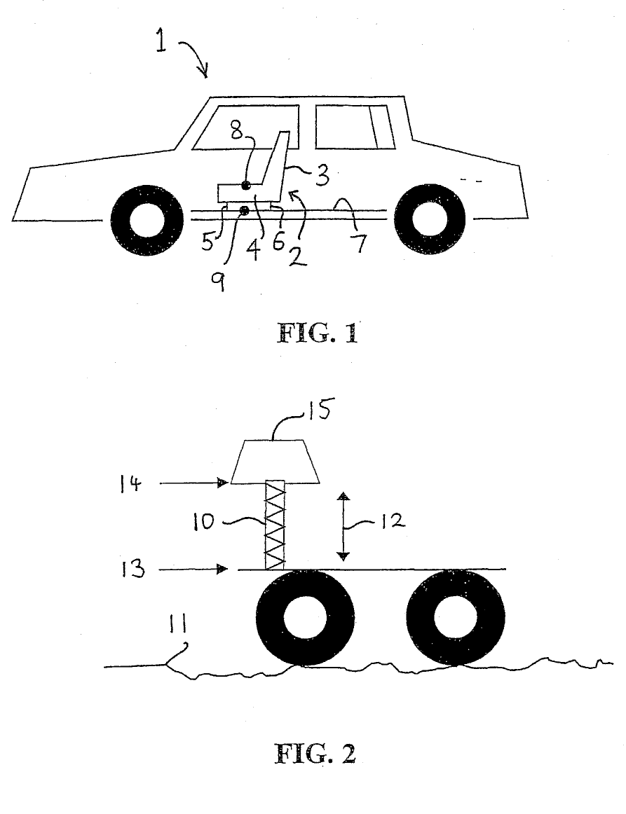

Referring to FIG. 1, a car 1 has a seat 2 comprising a back-rest 3 and base 4 with legs 5,6 rigidly mounted to the car chassis 7. The base 4 is formed with polyurethane foam padding. A target vibration sensor 8 is mounted in the base 4 at a central upper position. A reference vibration sensor 9 is mounted substantially vertically below the sensor 8 on the chassis 7. The sensors 8,9 may be a sheet of PVDF enclosed between a pair of sensor electrodes, as shown in more detail in WO 00/13582. Alternatively more inexpensive vibration sensors may be used.

The sensors 8,9 form part of an inertial PPPD (passive passenger presence detection) system which uses the natural vibration in a moving car as a wideband signal source in conjunction with the elastic characteristics of the seat to determine the presence of a person or object on a seat. The general principle is that a mechanical signal from engine/transmission vibration and road vibration is applied to the rigid fixing points of the seat. This vibration can be sensed by the reference sensor 9. To some extent this vibration is transmitted to the top surface of the base 4 of the seat, where it can be measured by the target sensor 8. If the seat is unloaded, then the top surface vibration will track the fixing point vibration but with a low pass characteristic due to the elastic nature of the seat springs and upholstery. However this bandwidth is relatively large, and the spectrum of the seat surface vibration can be divided by the seat fixing point vibration spectrum to give a frequency domain transfer function.

If, however, the seat is loaded with a massive object (such as a human body), then this object will tend to remain stationary (with respect to the average spatial position of the car), while the seat fixing points are vibrated with the mechanical signal sources described above. The body or object in conjunction with springiness of the seat acts as a mechanical low pass filter on the original seat fixing point reference signal. Once again, dividing the spectrum of the seat surface vibration by the seat fixing point vibration yields another spectrum, which is the loaded seat transfer function in the frequency domain.

The loaded seat transfer function will show a much lower bandwidth than that of the unloaded seat, and it is from this that a seat occupancy signal can be derived.

A good mechanical analogy to this system is shown below in FIG. 2. The seat structure is analogous to a damped spring 10. As the car moves over a road surface 11 the spring 10 vibrates as indicated at 12. The reference sensor 9 picks up a reference signal at point 13. The target sensor 8 picks up a target vibration signal at point 14. The target vibration signal varies in accordance with the weight of an object 15 (typically a human seat occupant) on the seat.

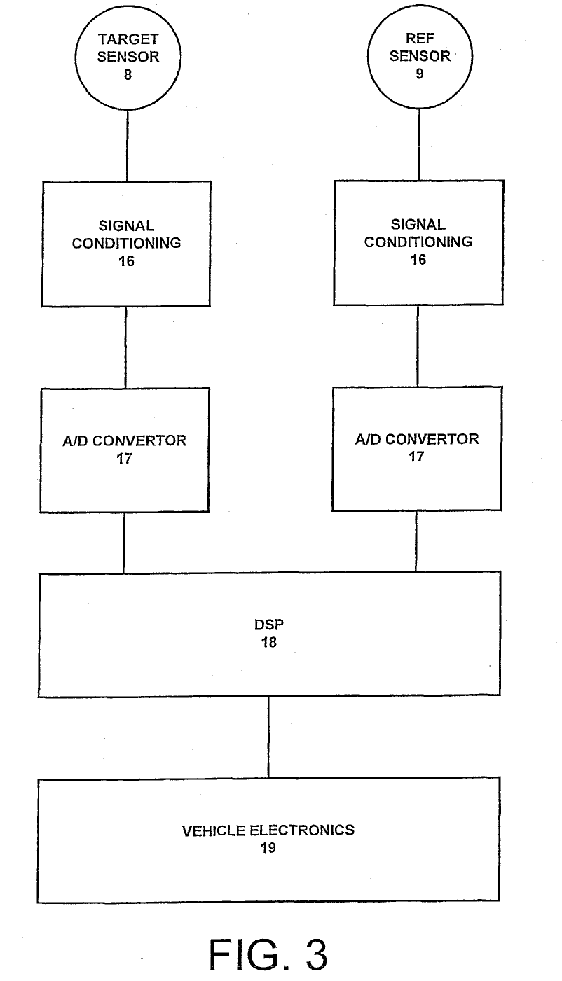

The sensors 8,9 are connected to electronics shown in. FIG. 3. The signals from the sensors are input to signal conditioning circuitry 16 which performs a number of tasks in the analogue domain, such as input protection, signal limiting, ground bootstrapping, low pass filtering, mains or other application-specific notch or comb filtering, and/or level translation for the following modules/circuits.

The signals from the conditioning circuitry 16 are input into analogue-to-digital converters 17 and then into DSP 18 which performs one or more of the processing algorithms described below.

### EXAMPLE ALGORITHMS

### Method One: Time Domain PPPD with Averaging

We process the signal in the time domain. Typically the data length M is 4096, using moving window, each 4 seconds, calculate the seat signal power and chassis signal power, to get the ratio of seat signal power to chassis signal power.

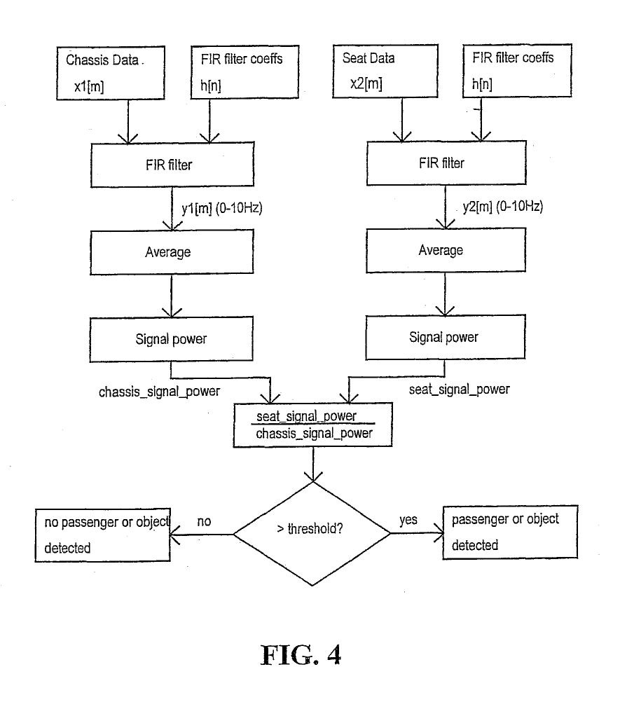

We design a hamming window filter to low pass the signal, get 0-10 Hz signal. Alternatively, a band-pass filter could be used. Calculate the signal average value and power, get the ratio. The procedures are shown in FIG. 4 and described below.

Fs—sampling frequency, 1000 Hz

fc—Cut off frequency, 10 Hz

N—filter length, 121

M—signal length, 4096

### 1. Filter Design

input: Fs, fc, N

Use the MatLab “fir1” filter algorithm, which includes a Hamming window, to generate a low pass finite impulse response (fir) filter, as follows:—

h=fir1(N,fc/(Fs/2)); % Matlab code

### 2. Filtering

input: signal X[m], filter coefficients h[n], m=0, . . . ,M−1, n=0, . . . ,N−1

output: lowpass 0-10 Hz signal, y[m]. m=0, . . . ,m−1

$$y ( m ) = {\sum }_{n = 0}^{N - 1} h ( n ) X ( m - n )$$

### 3. Average

input: y[m]

output: \overline{y}, average value of 0-10 Hz signal

$$\overline{y} = \frac{{\sum }_{m = 0}^{M - 1} y [ m ]}{M}$$

### 4. Power

input: average \overline{y}, filtered signal y[m]

output: power

$$power = \sqrt{\frac{{\sum }_{m = 0}^{M - 1} {( y [ m ] - \overline{y} )}^{2}}{M}}$$

### 5. Transfer Function

input: seat_signal_power, chassis_signal_power

output: transfer function

$$transfer function = \frac{seat\_signal \_power}{chassis\_signal \_power}$$

### 6. If Transfer Function>Threshold, the Seat is Loaded

If the rms power of the reference signal falls to zero, then an alternative method for monitoring the seat (for example a conventional pressure-sensitive switch, or a cardiac/respiratory measurement as described in WO 00/13582) can be temporarily used.

If only a single reference sensor 9 is used, then there is a chance that it may lie at a node of a standing wave in the chassis, resulting in a small (or at worst unmeasurable) signal. To minimise the chance of this occurring, two or more reference sensors 9 may be installed.

### Method Two: Frequency Domain PPPD with Transfer Function Power Detection

We process the data in the frequency domain.

Typically the data length, M, is 4096, Fs=1000 Hz, fc=10 Hz. using moving window every 4 seconds, calculate the signal power transfer function.

We apply a Fast Fourier Transform to the chassis signal and the seat signal, then calculate the transfer function in 0-10 Hz, and then get signal power transfer function in this bandwidth (0-10 Hz).

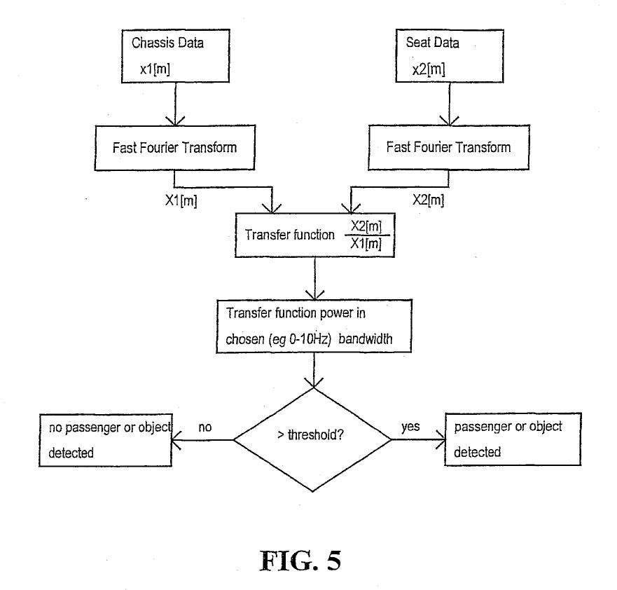

The procedures are shown in FIG. 5 and described below.

### 1. FFT

input: signal x[m], m=0, . . . ,m−1, time domain

output: signal X[m], m=0, . . . ,M−1, frequency domain

$$X ( K ) = {\sum }_{m = 0}^{\frac{M}{2} - 1} {x}_{2 m} {ω}_{m / 2}^{mK} + {ω}_{m}^{K} {\sum }_{m = 0}^{\frac{M}{2} - 1} {x}_{2 m + 1} {ω}_{m / 2}^{mK} K = O , … , M - 1$$

where:

ωₘ=e^{-j2π/m}

ωₘ²=ω_{m/2}

ωₘ^{(K+m/2)}=−ωₘ^{K}

### 2. Transfer Function

input: seat data X₂[m], chassis data X₁[m]

output: X_transfer[m]

$$X\_transfer [ m ] = \frac{{X}_{2} [ m ]}{{X}_{1} [ m ]}$$

### 3. Transfer Power

input: transfer function data X-transfer[m]

output: transfer_power

$$transfer\_power = \sqrt{\frac{{\sum }_{m = 0}^{M - 1} {( X\_transfer [ m ] )}^{2}}{M}}$$

### 4. if Transfer_Power>Threshold, the Seat is Loaded

The result of the thresholding step is input to vehicle electronics 19 (see FIG. 3) where it can be used for a number of purposes, for example to enable/disable an airbag system.

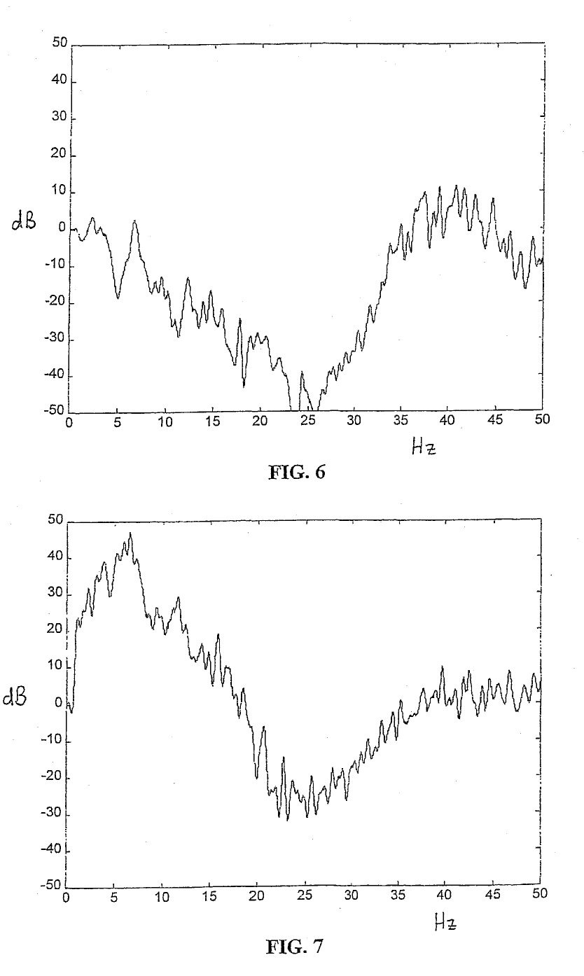

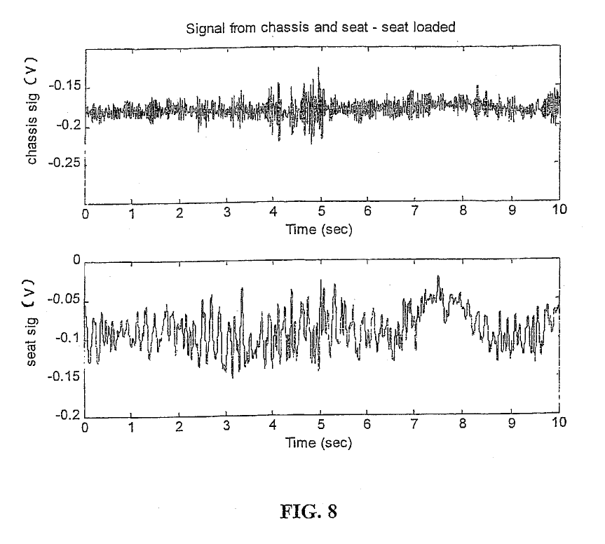

Experimental signals are shown in FIGS. 6-8. FIG. 6 shows the transfer function calculated in step 2 of the FIG. 5 ‘frequency domain’ embodiment when the seat is unloaded. We can see that the transfer function starts at about 0 dB, drifts down to a minimum at about 25 Hz and then rises back up to approximately 0 dB at 35-45 Hz. When the seat is loaded, the transfer function shown in FIG. 7 shows significant peaking in the 5-15 Hz range compared to the unloaded state. The enhanced lower frequency components of the seat signal can also be observed in the time domain, as shown in FIG. 8 which compares the seat signal (lower signal in FIG. 8) with the chassis signal (upper signal in FIG. 8) with the seat loaded. This can be understood intuitively as a resonant effect resulting from the change in transfer characteristics of the seat when it becomes loaded.

Although the embodiments described above analyse signals in the 0-10 Hz band, other bands such as 5-15 Hz may also be analysed.

### Method Three: Frequency Domain PPPD with Pattern Detection

This method is a variant of method three, in which we also process the data in the frequency domain.

Typically the data length, M, is 4096, Fs=1000 Hz, fc=10 Hz. using moving window every 4 seconds, calculate the signal power transfer function.

We apply a Fast Fourier Transform the chassis signal and the seat signal, then calculate the transfer function in 0-10 Hz, and then get signal power transfer function in this bandwidth (0-10 Hz).

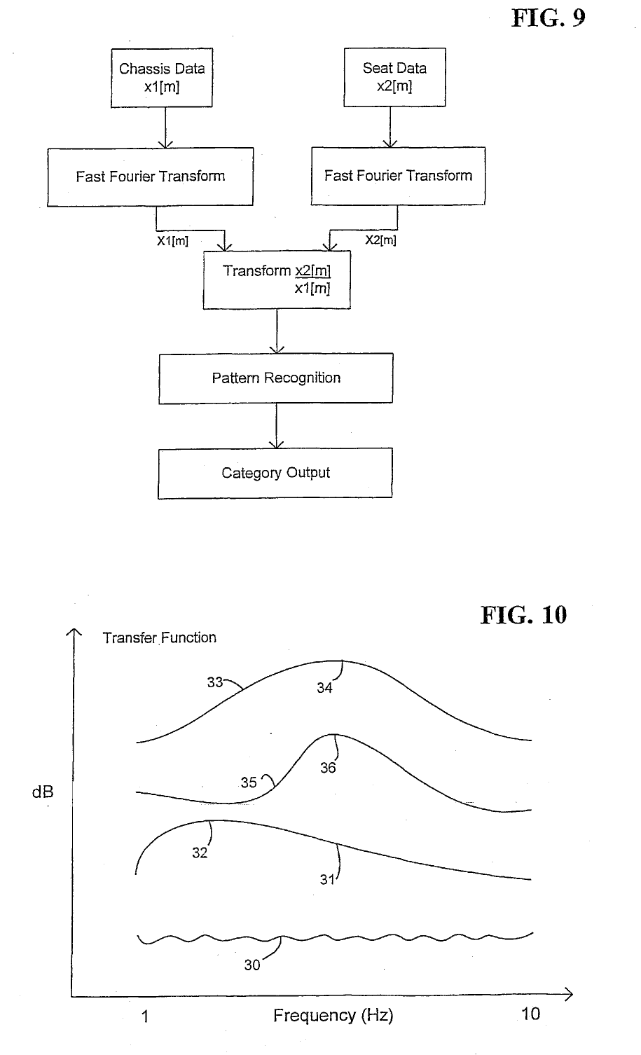

The procedures are shown in FIG. 9 and described below.

### 1. FFT

input: signal x[m], m=0, . . . ,m−1, time domain

output: signal X[m], m=0, . . . ,M−1, frequency domain

$$X ( K ) = {\sum }_{m = 0}^{\frac{M}{2} - 1} {x}_{2 m} {ω}_{m / 2}^{mK} + {ω}_{m}^{K} {\sum }_{m = 0}^{\frac{M}{2} - 1} {x}_{2 m + 1} {ω}_{m / 2}^{mK} K = O , … , M - 1$$

where:

ωₘ=e^{-j2π/m}

ωₘ²=ω_{m/2}

ωₘ^{(K+m/2)}=−ωₘ^{K}

### 2. Transfer Function

input: seat data X₂[m], chassis data X₁[m]

output: X_transfer[m]

$$X\_transfer [ m ] = \frac{{X}_{2} [ m ]}{{X}_{1} [ m ]}$$

### 3. Pattern Detection

input: transfer function data X-transfer[m]

output: occupant category

Instead of calculating the transfer power (step 3 of method two), in method three, a pattern recognition engine analyses the transfer function data over a selected wavelength range. FIG. 10 is a graph schematically illustrating four different transfer function curves in the 1-10 Hz wavelength range. Lower curve 30 is with the seat unloaded. It can be seen that curve 30 is relatively flat and featureless. Curve 31 is with a child (weight<30 kg) in the seat, and has a peak 32. Curve 33 is with an adult (weight>45 kg) in the seat, and has a peak 34. It can be seen that curve 33 is generally higher than curve 31, and also peak 34 is at a higher frequency than peak 32. Finally, curve 35 is with a bag of rice on the seat, and has a peak 36. It can be seen that peak 36 is narrower than peaks 32 and 34.

Broadly speaking, the pattern recognition engine can either apply statistical or deterministic methods. In statistical methods, the pattern recognition engine comprises a network which is ‘trained’ by inputting large quantities of appropriate data in each category. For instance a variety of children with weight less than 30 kg are sat on the seat, and the network learns to recognise the shape of curve attributable to subjects in this category. Thus the network can learn to distinguish between the various categories of input. Some of the underlying techniques (which are related), include neural networks, genetic/evolutionary algorithms and hidden Markov modelling. Typical categories of input may be:

Category A: infant<1 year old, typically <10 kg, in an infant car seat

Category B: child<30 kg sitting directly on seat or on a booster seat

Category C: adult>48 kg sitting directly on the seat

Suitable deterministic pattern detection techniques include template correlation, Karhunen-Loeve Transforms (principal component analysis); Ritz Approximation; Sparse filter representations such as Gabor jets and wavelet analysis; Independent Component Analysis/Blind Source Separation (built upon Higher Order Cumulants/Spectra) and Fisher discriminants.

In a basic system, the pattern recognition engine may simply distinguish between an inanimate object and an animate object. In a more sophisticated system, the pattern recognition engine may be able to distinguish between the categories illustrated in FIG. 10.

It can be envisaged that pattern recognition techniques as discussed above could be used in a biometric security system. Although the data may in itself not be sufficient to discriminate between individuals, it could provide useful information to supplement information provided by other biometric data (such as voice or fingerprint data).

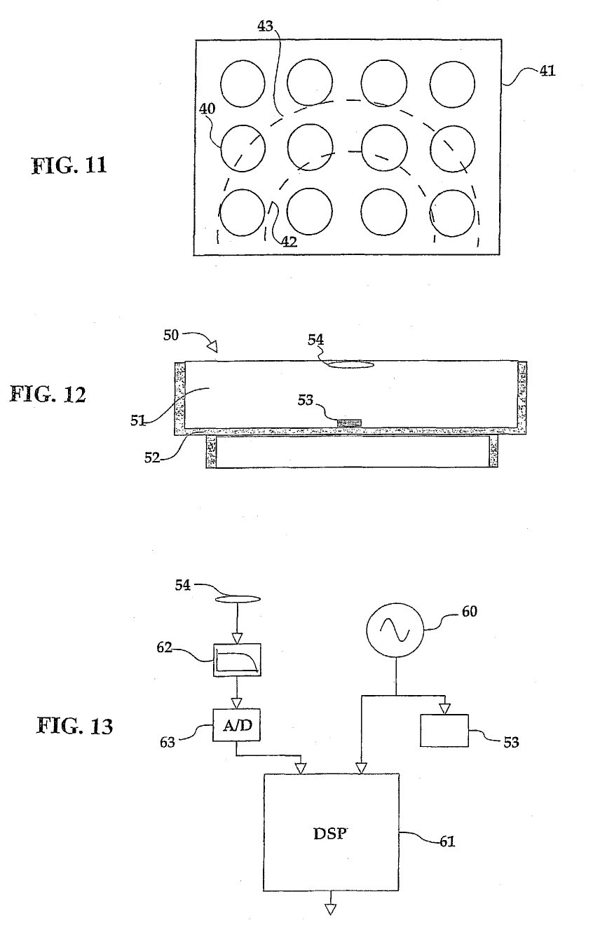

Although only a single seat sensor 8 and a single chassis sensor 9 are shown in FIG. 1, it will be appreciated that more sensors could be used to provide further data if desired. A potential use of an array of target sensors is shown in FIG. 11. A rectangular array of twelve circular seat sensor electrodes 40 is provided on a sheet 41 which is placed on top of the seat base 4, or incorporated into the structure of the seat base 4. A single references sensor 9 may be used, or multiple reference sensors can be utilised, for example to ensure that at least one reference sensor is not at a node in a standing wave, so that at least one reference sensor gives sufficient input levels. A child in the seat will form a relatively small profile indicated by dotted lines 42, compared to an adult with a profile 43. Thus the differences between the signals from the sensors can be analysed to supplement the direct information from the sensors. For instance the edge sensor labelled 40 will not detect any weight with a child in the seat, but only with an adult in the seat.

An alternative system is shown in FIG. 12. A stationary bed 50 (for example a hospital bed) has a mattress 51 on a base 52. A source of mechanical vibration 53 is mounted in the base 52. One or more target sensors 54 are mounted towards the upper face of the mattress 51 directly above the source of mechanical vibration 53.

A circuit diagram is shown in FIG. 13. A signal generator 60 generates a wideband reference signal (such as a pseudorandom binary sequence) which is input to vibrator 53 and DSP 61. The signal from sensor 54 is input to signal conditioning circuitry 62 which performs a number of tasks in the analogue domain, such as input protection, signal limiting, ground bootstrapping, low pass filtering, mains or other application-specific notch or comb filtering, and/or level translation for the following modules/circuits. The signals from the conditioning circuitry 62 are input into analogue-to-digital converter 63 and then into the DSP 61 which performs one or more of the processing methods described above.

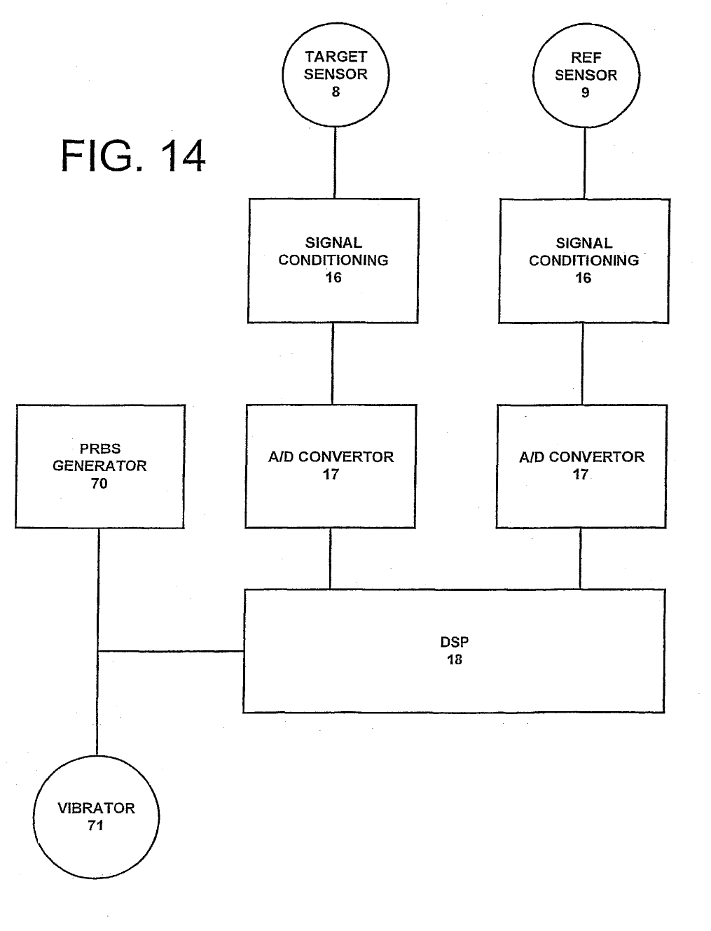

In a further alternative, instead of acquiring the reference signal from the signal generator, the reference signal may be generated by one or more reference sensors mounted in the base 52 near the source of mechanical vibration 53. An example is given in FIG. 14. Many of the components are identical to the components shown in FIG. 3, and like reference numerals are used for these components.

Signal generator 70 generates a pseudo-random binary sequence (PRBS) which is input to a means for mechanical vibration 71, mounted next to the reference sensor 9. As a result the vibration signals picked up by the sensors 8,9 each include the PRBS. The DSP 18 also receives the PRBS from the generator 70. The algorithm performed by the DSP 18 includes the step of correlating the vibration signals from the sensors 8,9 with the PRBS from the generator 70. The two correlation coefficients are then divided to give the transfer function. This process of correlation is similar to the process described in copending application WO 01/33245, FIGS. 5 and 6, the disclosure of which is incorporated herein by reference. A suitable PRBS is chosen having a range of frequencies within the frequency band of interest (eg 0-10 Hz). The DSP 18 may also compare the relative phase of the sequences from the two sensors.

Although various methods are illustrated separately above, it will be appreciated that the DSP could perform two or more of the methods in parallel if desired.

Where in the foregoing description reference has been made to integers and elements having known equivalents, then such equivalents are incorporated as if individually set forth.

Although this invention has been described by way of example and with reference to possible embodiments thereof, it is to be understood that modifications and improvements may be made without departing from the spirit or scope of the invention.

1. A method of determining the presence and/or absence and/or a characteristic of an object on a support, the method including the steps of:
a) acquiring a target signal indicative of vibration of the support at a first location;
b) acquiring a reference signal indicative of vibration of the support at a second location;
c) calculating a ratio of the target signal and the reference signal; and
d) determining the presence and/or absence and/or a characteristic of an object on the support in accordance with the ratio determined in step c).

2. The method of claim 1, wherein the target signal is acquired in step a) by receiving a target vibration signal from a sensor mounted on the support at the first location and processing the target vibration signal to calculate a first signal characteristic which varies in accordance with the presence and/or absence and/or a characteristic of an object on the support; and wherein the reference signal is acquired in step c) by receiving a reference vibration signal and processing the reference vibration signal to calculate a second signal characteristic; and wherein step c) includes the step of calculating the ratio of the first and second signal characteristics.

3. The method of claim 2 wherein the first and second signal characteristics are indicative of an average power of vibration of the support at the first and second locations during a predetermined time period.

4. The method of claim 2 wherein the first and second signal characteristics are indicative of a power of vibration of the support at the first and second locations in a predetermined wavelength band.

5. The method of claim 4 wherein the signals are calculated by Fourier transforming the target and reference vibration signals.

6. The method of claim 2 wherein the first and second signal characteristics are correlation coefficients indicative of a degree of correlation between the vibration signals and a predetermined encoded sequence.

7. The method of claim 6 wherein the predetermined encoded sequence is a pseudo-random sequence.

8. The method of any of the preceding claims wherein the reference signal is acquired in step b) from a sensor mounted at the second location.

9. The method of any of the preceding claims further including the steps of generating the reference signal with a signal generator; and inputting the reference signal to a source of mechanical vibration to vibrate the support at the second location in accordance with the reference signal.

10. The method of claim 9 wherein the signal generator inputs a predetermined encoded sequence into the source of mechanical vibration.

11. The method of claim 9 or 10 wherein the reference signal is acquired in step b) from the signal generator.

12. The method of any of the preceding claims wherein a plurality of ratio values are calculated in step c); and wherein the presence and/or absence and/or weight of an object on the support is determined in step d) by performing a pattern recognition algorithm on the plurality of ratio values.

13. The method of claim 12 further including the step of training a pattern recognition network to perform the pattern recognition algorithm by inputting a plurality of sets of training data values into the pattern recognition network.

14. The method of any of the preceding claims wherein step d) includes the step of distinguishing between different categories of object.

15. The method of any of the preceding claims wherein the support is located in a vehicle.

16. The method of any of the preceding claims further including the steps of: acquiring one or more additional target signals indicative of vibration of the support at one or more additional locations; calculating one or more additional ratios using the additional target signal(s); and determining the presence and/or absence and/or a characteristic of an object on the support in step d) in accordance with the additional ratio(s).

17. The method of any of the preceding claims wherein the object is a human or animal subject.

18. Apparatus for determining the presence and/or absence and/or a characteristic of an object on a support, the apparatus including:
a) means for acquiring a target signal indicative of vibration of the support at a first location;
b) means for acquiring a reference signal, the reference signal being indicative of vibration of the support at a second location;
c) means for calculating a ratio of the target signal and the reference signal; and
d) means for determining the presence and/or absence and/or a characteristic of an object on the support in accordance with the calculated ratio.

19. The apparatus of claim 18, wherein the means for acquiring a target signal comprises a target sensor for generating a target vibration signal and means for receiving and processing the target vibration signal to calculate a first signal characteristic which varies in accordance with the presence and/or absence and/or a characteristic of an object on the support; and wherein the means for acquiring a reference signal receives a reference vibration signal and processes the reference vibration signal to calculate a second signal characteristic.

20. The apparatus of claim 19 wherein the first and second signal characteristics are indicative of an average power of vibration of the support at the first and second locations during a predetermined time period.

21. The apparatus of claim 19 wherein the signals are indicative of a power of vibration of the support at the first and second locations in a predetermined wavelength band.

22. The apparatus of claim 21 wherein the signals are calculated by Fourier transforming the target and reference vibration signals.

23. The apparatus of any of claims 18 to 22 wherein the means for acquiring a reference signal includes a sensor mounted at the second location.

24. The apparatus of any of claims 18 to 23 further including a source of mechanical vibration for vibrating the support at the second location; and a signal generator for generating the reference signal and inputting the reference signal to the source of mechanical vibration.

25. The apparatus of claim 24 wherein the reference signal is acquired from the signal generator.

26. The apparatus of any of claims 18 to 25 wherein a plurality of ratio values are calculated; and wherein the means for determining the presence and/or absence and/or a characteristic of an object on the support includes a pattern recognition engine for performing a pattern recognition algorithm on the plurality of ratio values.

27. The apparatus of claim 26 wherein the pattern recognition engine includes a pattern recognition network which has been trained to perform the pattern recognition algorithm by inputting a plurality of sets of training data values into the pattern recognition network.

28. The apparatus of any of claims 18 to 27 wherein the means for determining can distinguish between different categories of object.

29. The apparatus of any of claims 18 to 28 installed in a support which includes a compressible material between the first and second locations.

30. The apparatus of any of claims 18 to 29 installed in a support which is situated in a vehicle.

31. The apparatus of any of claims 18 to 30 including one or more additional target sensors for acquiring one or more additional target signals indicative of vibration of the support at one or more additional locations.

32. The apparatus of any of claims 18 to 31 including one or more additional reference sensors for acquiring one or more additional target signals indicative of vibration of the support at one or more additional locations.

33. The apparatus of any of claims 18 to 32 adapted to determine the presence and/or absence and/or a characteristic of a human or animal subject on the support.
